(19) United States
(12) Patent Application Publication
(10) Pub. No.: US 2012/0287050 A1
(43) Pub. Date: Nov. 15, 2012

(54) SYSTEM AND METHOD FOR HUMAN INTERFACE IN A VEHICLE

(76) Inventor: Fan Wu, Shanghai (CN)

(21) Appl. No.: 13/467,262

(22) Filed: May 9, 2012

Related U.S. Application Data
(60) Provisional application No. 61/485,420, filed on May 12, 2011.

(51) Int. Cl. G06F 3/02

(52) U.S. Cl. 345/168

(57) ABSTRACT

A system and method for providing an interface between a driver or passenger of a vehicle and a personal computing device. A projector projects an image onto a driver-facing surface of a steering wheel or other interior surface of the vehicle. At least one gesture sensor senses the person's finger gestures to determine the individual characters being typed or to sense specific commands being entered. The image may comprise a simulated computer keyboard and/or a touchpad.

### CROSS REFERENCE TO RELATED APPLICATIONS

The present application claims the benefit of U.S. Provisional Patent Application Ser. No. 61/485,420 filed May 12, 2011 which is hereby incorporated by reference in its entirety to the extent not inconsistent.

### TECHNICAL FIELD OF THE DISCLOSURE

The present disclosure relates to human-computer interface systems for use in vehicles. More specifically, the present disclosure relates to a system and method for providing an interface between a driver or passenger of a vehicle and a personal computing device.

### BACKGROUND OF THE INVENTION

As the availability of mobile computing and communication devices has grown in recent years, individuals increasingly desire to use these devices while performing other tasks, such as while driving a vehicle. Of course, in current vehicles, such use can be extremely dangerous, as it distracts the user from the task of driving. Even in “self driving” vehicles, which may become available in the near future, the vehicle's steering wheel presents a physical obstacle which prevents the comfortable use of a separate keyboard or other computer input device while sitting in the driver seat. Passengers may also desire to use such devices, yet the interiors of most vehicles limit the availability of convenient and comfortable placement options. Improved systems and methods are therefore needed which allow a person to safely and comfortably interact with a personal computing device while driving or riding as a passenger in a vehicle.

### SUMMARY OF THE INVENTION

According to one aspect, a system for providing an interface between a person in a vehicle and a personal computing device is disclosed, comprising at least one projector located in the vehicle for projecting an image onto an interior surface of the vehicle, said image comprising a simulated computer keyboard, at least one gesture sensor for sensing a finger gesture of the person with respect to locations of individual characters within said image, and a computer processor operatively connected to said at least one projector and said at least one gesture sensor, wherein the computer processor receives and processes input from the at least one gesture sensor to determine a first character being selected by the person within said keyboard. The image may further comprise a simulated computer touchpad, wherein the computer processor receives and processes input from the at least one gesture sensor to determine a first input command being entered by the person in the simulated computer touchpad.

According to another aspect, a system for providing an interface between a person in a vehicle and a personal computing device is disclosed, comprising at least one projector for projecting an image onto an interior surface of the vehicle, said image comprising a simulated computer keyboard a physical sensing device located within said interior surface, and a computer processor operatively connected to said at least one projector and said physical sensing device, wherein the computer processor receives and processes input from the physical sensing device to determine a first character being entered by the person within said physical touchpad. The physical sensing device may be camouflaged within the interior surface when the image is not being projected.

### BRIEF DESCRIPTION OF THE DRAWINGS

FIG. 1 is a schematic block diagram of a system for providing an interface between a person in a vehicle and a personal computing device according to a first embodiment.

FIG. 2 is a schematic illustration of a system for providing an interface between a person in a vehicle and a personal computing device according to the first embodiment.

FIG. 3 is a schematic illustration showing an image of a keyboard and touchpad being projected onto the steering wheel of a vehicle when the steering wheel is in the home position according to the first embodiment.

FIG. 4 is a schematic illustration showing an image of a keyboard and touchpad being projected onto the steering wheel of a vehicle when the steering wheel is rotated from the home position according to the first embodiment.

FIG. 5 is a schematic illustration of a system for providing an interface between a person in a vehicle and a personal computing device according to a second embodiment.

FIG. 6 is a schematic illustration showing an image of a keyboard and touchpad being projected onto the steering wheel of a vehicle when the steering wheel is in the home position according to the second embodiment.

FIG. 7 is a schematic illustration showing an image of a keyboard and touchpad being projected onto the steering wheel of a vehicle when the steering wheel is rotated from the home position according to the second embodiment.

FIG. 8 is a schematic illustration showing an image of a keyboard and touchpad being projected onto the steering wheel of a vehicle when the steering wheel is in the home position according to a third embodiment.

FIG. 9 is a schematic illustration showing an image of a keyboard and touchpad being projected onto the steering wheel of a vehicle when the steering wheel is rotated from the home position according to the third embodiment.

FIG. 10 is a schematic illustration showing and image of a split keyboard and touchpad being projected onto the steering wheel of a vehicle.

FIG. 11 is a schematic illustration showing a side view of a steering wheel having a physical touchpad embedded beneath or within the driver-facing surface of a steering wheel.

### DETAILED DESCRIPTION OF THE PREFERRED EMBODIMENTS

For the purposes of promoting an understanding of the principles of the invention, reference will now be made to the embodiment illustrated in the drawings and specific language will be used to describe the same. It will nevertheless be understood that no limitation of the scope of the invention is thereby intended, and alterations and modifications in the illustrated device, and further applications of the principles of the invention as illustrated therein are herein contemplated as would normally occur to one skilled in the art to which the invention relates.

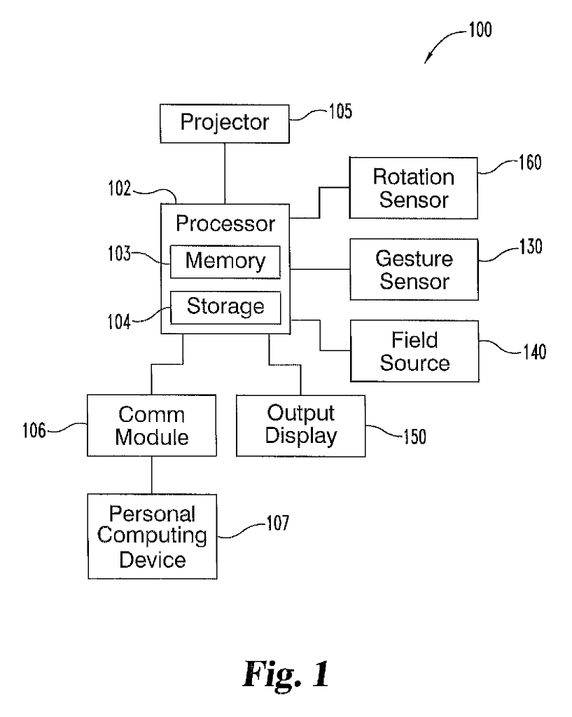

FIG. 1 shows a block diagram of a system 100 for providing a human-computer interface within a vehicle according to a preferred embodiment of the present disclosure. The system includes a computer processing unit 102, having a memory 103 and digital storage unit 104 operatively connected thereto. The system 100 may also include a projector 105, gesture sensor 130, field source 140, output display 150 and rotation sensor 160, all in operative communication with the computer processing unit 102. It shall be understood that the individual components of the system 100 may be included in a common housing or in separate housings, depending on the needs of the application.

The system 100 may also optionally comprise a communication module 106 for transmitting information to and from a personal computing device 107. The personal computing device 107 may comprise a smart phone, a laptop computer, a tablet computer, or any other personal computing device known in the art. In addition to personal computing devices, the communication module 106 may operatively communicate with other dedicated electronic devices within the vehicle, such as GPS navigation devices, and audio and video entertainment devices, such as MP3 players, DVD players, and the like. The communication module 106 may communicate with the personal computing device 107 using any wired or wireless protocol known in the art, including Bluetooth, Universal Serial Bus (USB), and the like. In addition, the communication module 106 may be connected to a network external to the vehicle, such as the Internet.

Output display 150 may communicate with the computer processing unit 102 either directly or through communication module 106. Output display 150 preferably comprises a digital display, such as an LCD screen, which displays the results of the user input being performed. In a preferred embodiment, the output display 150 is incorporated as part of the vehicle dash instrument cluster. In other embodiments, output display 150 may comprise a heads up display or other in-vehicle display.

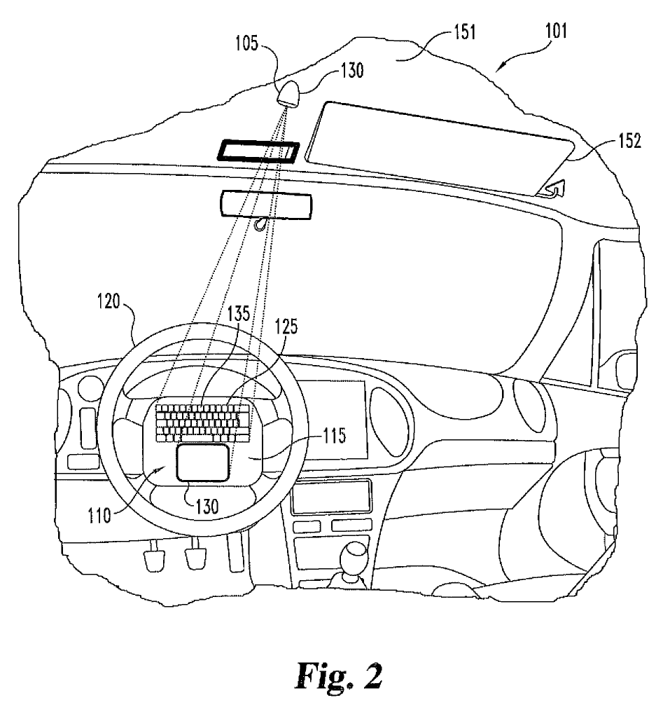

As shown in FIG. 2, the projector 105 projects an image 110 onto the driver-facing surface 115 of a steering wheel 120. The image 110 may comprise a simulated computer keyboard 125, a simulated touchpad 130, or a combination thereof. The keyboard 125 preferably comprises a QWERTY arrangement, to allow ease of use and familiarity for the user. In one embodiment, the projector 105 may comprise a device which uses laser light to project the image 110 onto the steering wheel 120. In further embodiments, other types of light projecting devices and methods known in the art may be utilized, such as Diffused Light Control (DLC) projection, Liquid Crystal Display (LCD) projection, Digital Light Processing (DLP) projection, and the like. In addition to steering wheel surfaces, the projected image 110 may be projected onto other vehicle interior surfaces, such as the passenger dashboard area, the rear surface of the front seats (for the rear passengers), and collapsible tray tables in the front or rear passenger areas.

In certain vehicles, the distance between the mounted projector 105 and the steering wheel may change during use. For example, the steering wheel 120 may be adjusted in a telescoping fashion to accommodate different drivers. To allow for this, the computer processing unit 102 may automatically adjust the focus of the image 110 to optimize it to account for adjustments in steering wheel positions. Manual focus and adjustment capability may also be provided depending on the needs of the particular application. In certain embodiments, multiple projectors 105 may be placed at separate locations and focused on a single image area to enhance the quality of the projected image 110. This further allows continuous projection in case one of the projectors 105 is blocked by the user's body or other obstacle. In other embodiments, each projector 105 may be used to project a separate portion of the overall image 110.

Field source 140, which may optionally be included within the housing of the projector 105, provides a sensing field in the area of the steering wheel surface 115. The gesture sensor 130, which may also be optionally included within the housing of the projector 105, is able to sense the location of the driver's fingers relative to the image 110 within the sensing field produced by field source 140. The computer processing unit 102 receives the location information and determines which one of the keys 135 within the simulated keyboard 125 the driver is attempting to select. The gesture sensor 130, along with the computer processing unit 102, may also detect and determine touchpad commands performed by the user, such as “click,” “drag,” etc. The computer processing unit 102 may use any gesture detection algorithm or format known in the art. In one embodiment, the computer processor may use OpenCV to perform the gesture detection.

In further embodiments, the displayed image 110 can be toggled between a keyboard and touchpad based on a predetermined input command from the user. For example, if the user wishes to switch to a touchpad-only input, she may simply perform a “drag” motion along the keyboard area Likewise, if the user wishes to switch to a keyboard-only input, she may simply begin to type, at which point the processor will recognize the typing action and switch to a keyboard-only mode.

In certain embodiments, the gesture sensor 130 may comprise a charge coupled device (CCD) camera. In other embodiments, the gesture detector 130 may comprise an infrared sensor, with field source 135 providing an infrared field which overlays the image 110 and allows the gesture sensor 130 to determine the location of the user's fingers within the sensing field. One example of a device which functions as a virtual laser projector and gesture sensor for keyboard input is the Magic Cube, supplied by Celluon, Inc. of Ace High-End Tower 918, 235-2 Guro-dong, Guro-Gu, Seoul, KOREA. Another example of a virtual laser projector is described in U.S. Pat. No. 6,611,252 issued Aug. 26, 2003 which is herein incorporated by reference.

As illustrated in FIG. 2, the projector 105 is preferably mounted to the interior roof portion 151 of the vehicle 100. The projector 105 is mounted far enough forward to avoid interference by the driver's head and body. Mounting the projector in the forward portion of the vehicle roof also allows easy access to the vehicle's electric accessory power wiring, which is typically located near the sun visor 152 for powering a vanity mirror light. This provides a convenient power supply (typically 12 volts in a car) for the projector 105 and other components of the system 100 when used in retrofit applications, and also allows increased image brightness for unlimited usage periods. For rear passengers, the projector 105 may be mounted in the rear portions of the interior roof, in addition to other suitable interior surfaces. Additional vehicle overhead lighting or accessory power wiring may also be used, such as a dome light or overhead video screen circuit. Still other types of power sources may be used, such as battery power, in order to simplify installation.

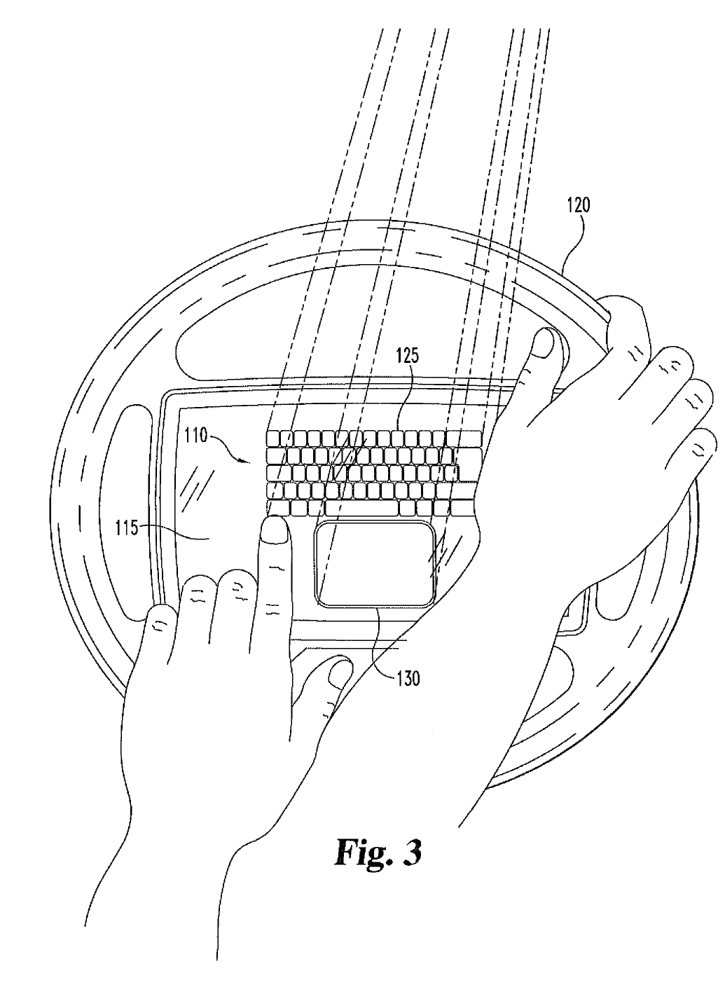

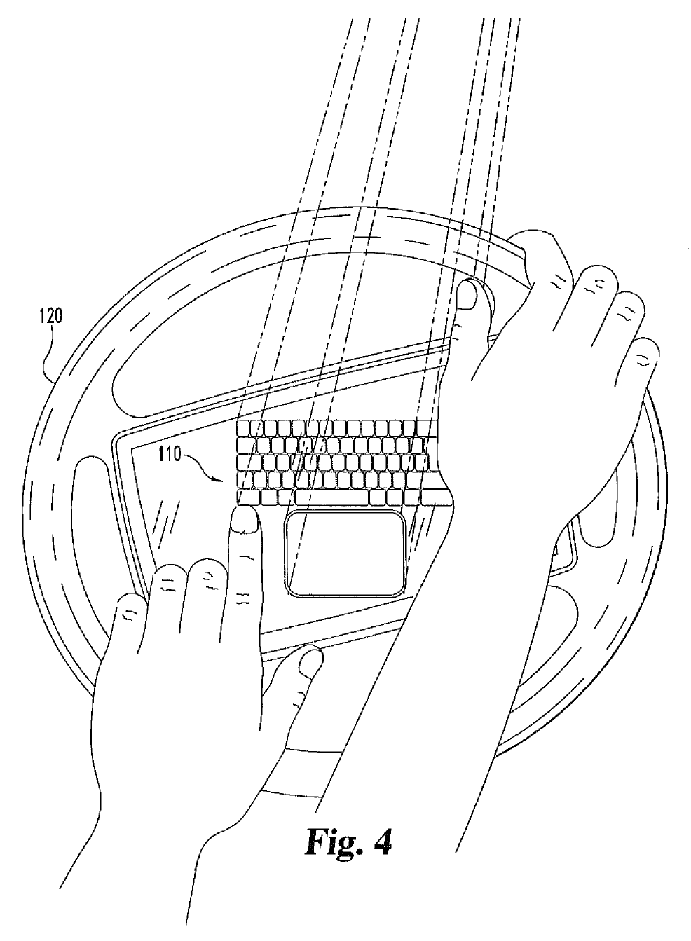

When installed in the roof portion 151 of the vehicle 100, the projector 105 will be fixed with respect to the driver. Therefore, the projected image 110 and the sensing field will automatically remain in the same orientation regardless of the rotation of the steering wheel 120, as illustrated in FIGS. 3 and 4. For vehicles which provide automatic steering capabilities, this allows the driver to continue to easily type on the simulated keyboard image 110 while the vehicle is turning.

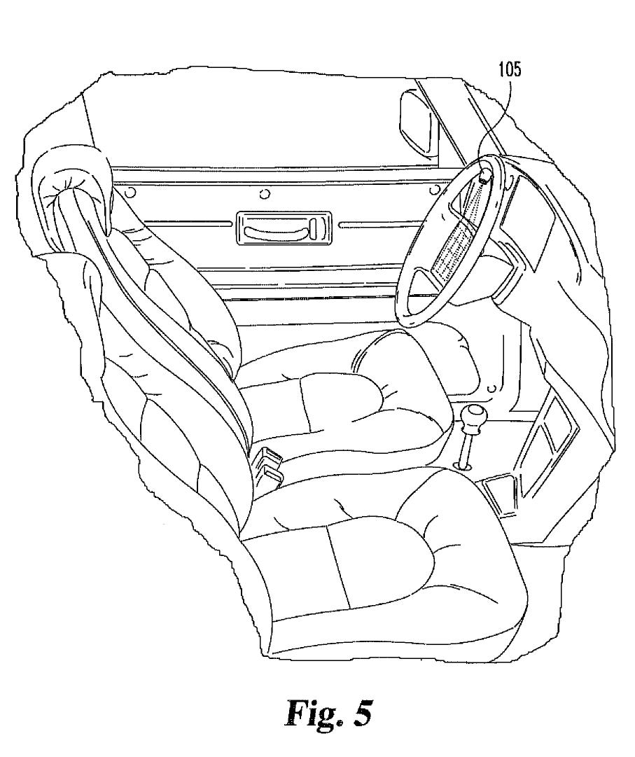

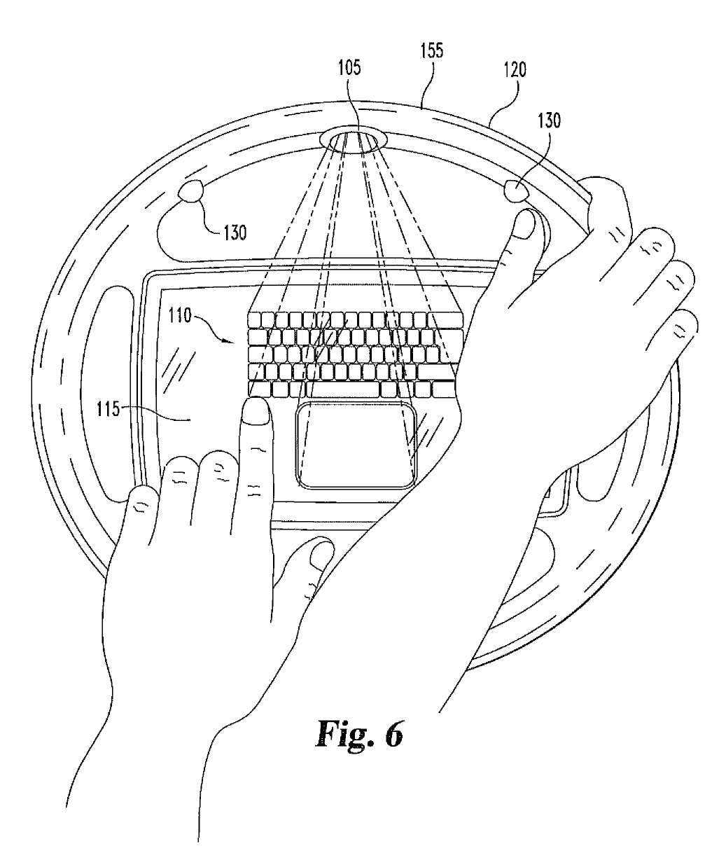

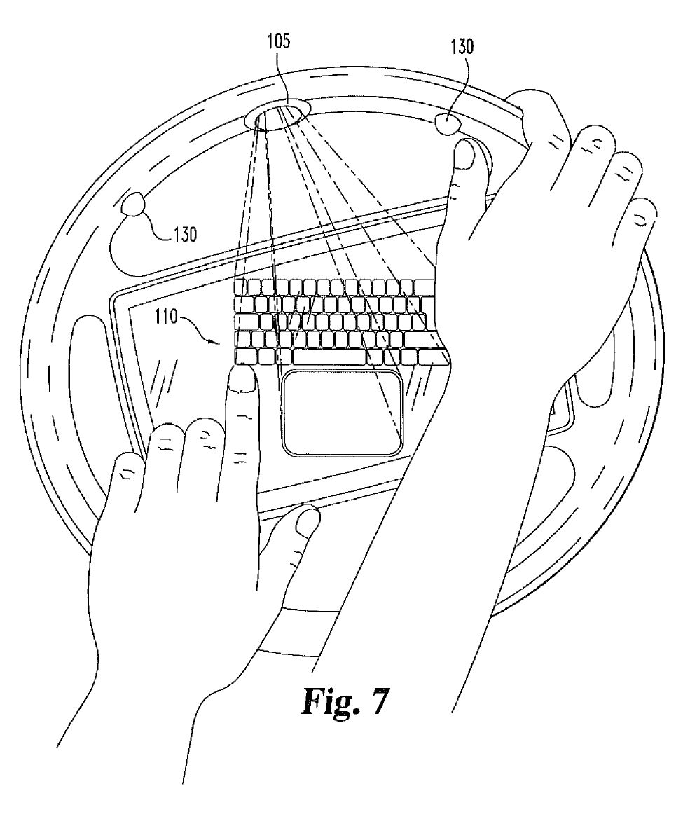

FIGS. 5-7 illustrates a further embodiment wherein the projector 105 is mounted on the grip portion 155 of the steering wheel 120. This allows the power requirements of the projector 105 and field source 140 to be reduced due to the close proximity of the components to the steering wheel surface. However, the projector 105 will now rotate with the steering wheel 120. To prevent the image from also rotating with the steering wheel, the computer processing unit 102 and projector 105 may optionally be programmed to change the orientation of the projected image 110 relative to the projector 105 to compensate for the rotational position of the steering wheel 120 (and the projector 105) as indicated by rotation sensor 160. Therefore, the image 110 remains fixed with respect to the vehicle and the driver regardless of the rotation of the steering wheel 120 (see FIGS. 6 and 7). Likewise, the computer processing unit 102 can be programmed to adjust the directional output of the field source 140 to account for the rotation of the steering wheel 120 (and gesture sensor 130) to keep the sensing field fixed with respect to the image 110. The processing unit 120 may be further configured to adjust the signals received from the gesture sensor 130 to account for the rotational position of the gesture sensor 130 as the steering wheel 120 rotates. In other embodiments, the image 110 and sensor field may be allowed to rotate with the steering wheel 120.

The rotation sensor 160 may comprise any type of sensor known in the art for detecting rotation of a steering wheel relative to a vehicle including accelerometers, gyroscopes, proximity switches, and the like. In other embodiments, the computer processing unit 102 may receive the steering wheel rotational position from the vehicle engine computer through a wired or wireless communication link.

In addition to a single gesture sensor 130, multiple gesture sensors 130 may be placed at separate locations with respect to the image 110, as shown in FIGS. 6 and 7, to improve the accuracy of the gesture detection functions of the system 100.

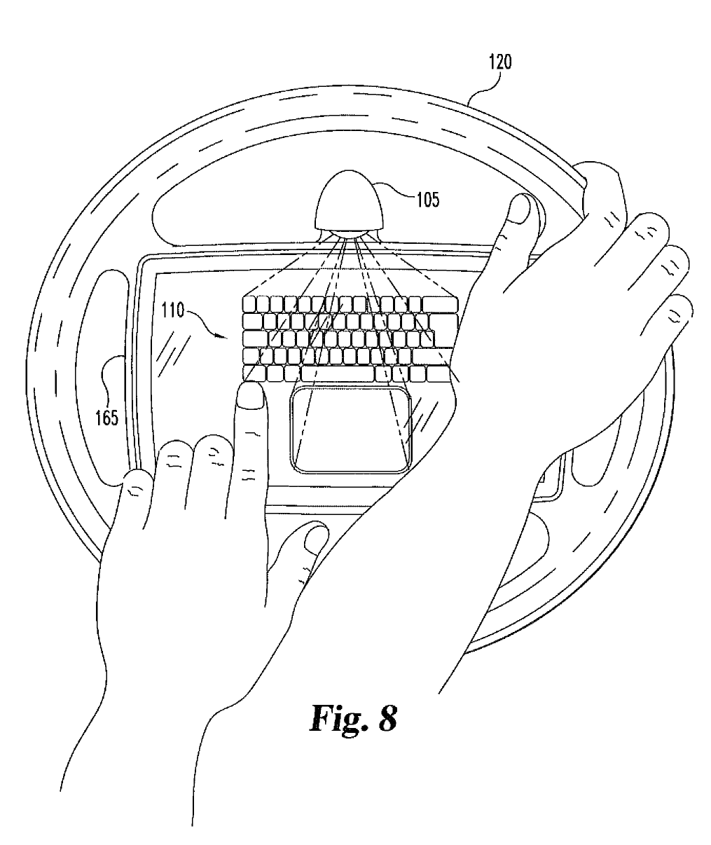

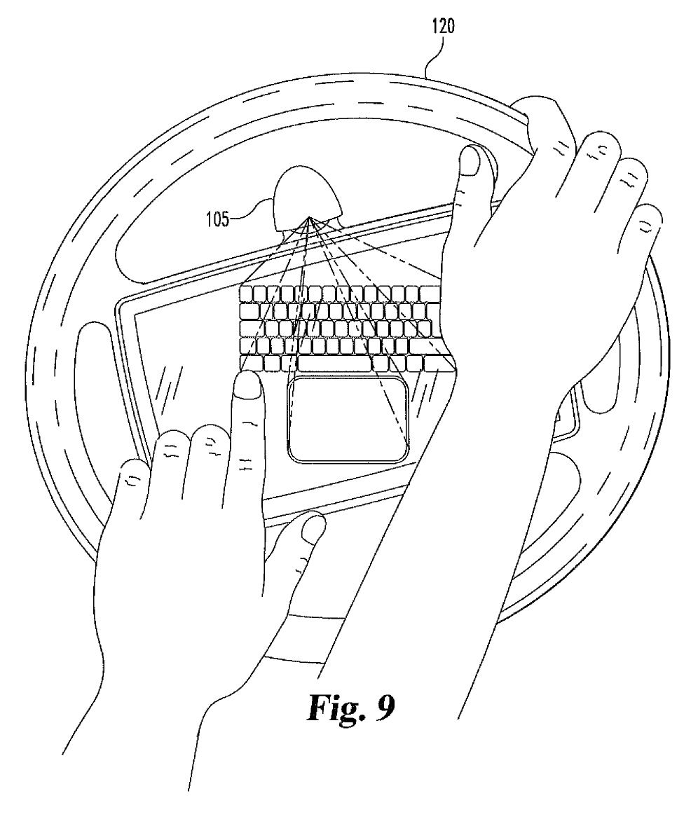

FIGS. 8 and 9 illustrate yet a further embodiment wherein the projector 105 is mounted to the central portion 165 of the steering wheel 120. This allows for even lower power requirements for the projector 105 and field source 140, while still maintaining the necessary image brightness and detection capabilities.

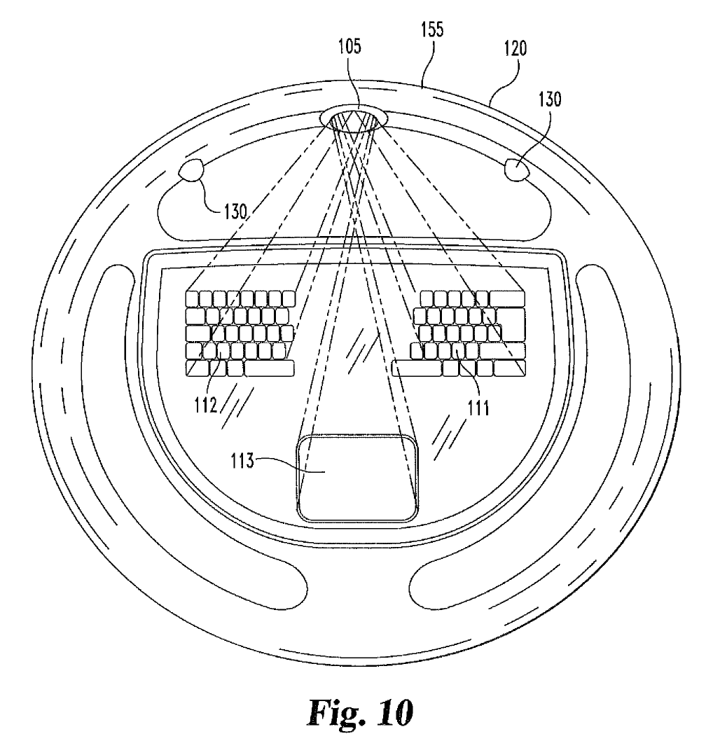

As shown in FIG. 10, the projected image may comprise separate portions 111 and 112 which are located near the upper left and upper right portions of the steering wheel 120, allowing the user to easily reach the keyboard keys when their hands are in the approximate ten o'clock and two o'clock positions. Touchpad area 113 may also be provided in a separate location, such as the lower-center portion of the steering wheel 120 as shown. Such placement of the touchpad likewise helps the user more easily reach the touchpad while keeping both hands on the grip portion 155 of the steering wheel 120. It shall be understood that the locations of the keyboard portions 111, 112 and touchpad portion 113 may be interchanged or overlaid in different combinations based on user preference.

In certain embodiments, where the color of the steering wheel surface 115 or other interior projection surface is very dark or does not otherwise allow for a quality image 110 to be viewed by the driver, an appropriately colored overlay may be attached to the surface 115 or other projection surface. The overlay is preferably white in color to improve the visibility of the projected image 110. The overlay may be formed from any suitable material and attached using an appropriate method including, but not limited to, adhesive, magnets, or elastic straps, to name a few. The overlay may be further configured to split or breakaway upon deployment of the vehicle airbag, which is typically contained within the central portion 165 of the steering wheel 120.

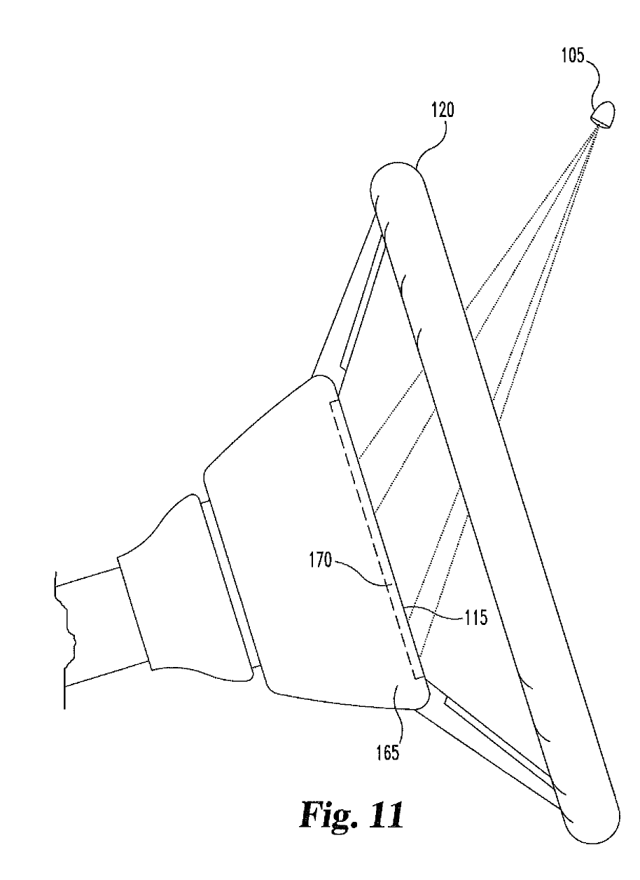

As shown from a side view in FIG. 11, a physical touchpad 170 may be provided within or below the surface 115 of steering wheel 120, with the projector 105 being used to visually indicate the designated locations of virtual keys within the physical touchpad 170. This allows the cost and complexity of the field source 140 and gesture sensor 130 to be reduced, since the sensing of individually-typed keys or touchpad actions can be accomplished using the physical touchpad via capacitance or other physical touch-based technologies, instead of optical gesture detection. This also provides a more pleasing aesthetic for the steering wheel 120 when the touchpad 170 is not in use. In addition to steering wheel surfaces, the physical touchpad 170 may be incorporated into other interior vehicles surfaces.

In certain embodiments, the physical touchpad 170 may be configured to be camouflaged within the surface 115 of the steering wheel 120. In other embodiments, the physical touchpad 170 may be placed beneath the surface 115, with the surface 115 being thin enough or made of an appropriate material to transfer the physical touch of the users fingers to the physical touchpad 170 (via capacitance, resistance, mechanical compaction, etc.). The physical touchpad 170 may also be pre-weakened or otherwise configured to breakaway when the vehicle airbag is deployed.

In further embodiments, a combination physical keyboard and touchpad, as opposed to a projected image, may be incorporated into the driver-facing surface 115 of the steering wheel 120. One example of such a combination keyboard and touchpad is described in U.S. Pat. No. 7,659,887 issued Feb. 9, 2010 and U.S. Patent Application Publication No. 2010/0148995 dated Jun. 17, 2010, both of which are hereby incorporated by reference.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A system for providing an interface between a driver in a vehicle and a personal computing device, comprising:
at least one projector located in the vehicle for projecting an image onto a driver-facing surface of a steering wheel in a vehicle, said image comprising a simulated computer keyboard;
at least one gesture sensor for sensing a finger gesture of the person with respect to locations of individual characters within said image; and
a computer processor operatively connected to said at least one projector and said at least one gesture sensor;
wherein the computer processor receives and processes input from the at least one gesture sensor to determine a first character being selected by the driver within said keyboard.

2. The system of claim 1,
wherein the image further comprises a simulated computer touchpad; and
wherein the computer processor receives and processes input from the at least one gesture sensor to determine a first input command being entered by the driver in the simulated computer touchpad.

3. The system of claim 1,
wherein the computer processor directs the at least one projector to adjust the image based on input received from the person to display either a simulated computer keyboard or a simulated touchpad, as selected by the driver.

4. The system of claim 1,
wherein the computer processor directs the at least one projector to automatically adjust the focus of the image to optimize it to account for adjustments in steering wheel positions.

5. The system of claim 1,
comprising a plurality of gesture sensors for sensing a finger gesture of the driver with respect to locations of individual characters within said image, each one of said plurality of gesture sensors being situated at different angles with respect to the image.

6. The system of claim 1,
wherein the at least one projector is mounted to an interior roof portion of the vehicle.

7. The system of claim 1,
wherein the at least one projector is mounted to a rotating portion of the steering wheel.

8. The system of claim 7, further comprising:
a rotation sensor operatively connected to said computer processor;
wherein said rotation sensor is configured to sense a first rotational position of the steering wheel with respect to the vehicle; and
wherein the computer processor directs the projector to maintain a second rotational position of the image regardless of the first rotational position of the steering wheel.

9. The system of claim 1,
wherein the at least one projector comprises a laser projector.

10. The system of claim 1, further comprising:
a field source for generating a sensing field;
wherein the sensing field substantially overlaps the image on the steering wheel; and
wherein the computer processor receives input from the at least one gesture sensor to determine the selected character location within said sensing field.

11. The system of claim 1,
wherein the field source emits infrared light.

12. The system of claim 1,
wherein said simulated computer keyboard comprises a QWERTY keyboard.

13. The system of claim 1,
wherein said simulated computer keyboard comprises at least two separated keyboard portions.

14. The system of claim 13, further comprising:
a simulated computer touchpad separate from the at least two keyboard portions, said touchpad situated near a bottom end of the steering wheel.

15. A system for providing an interface between a person in a vehicle and a personal computing device, comprising:
at least one projector for projecting an image onto an interior surface of the vehicle, said image comprising a simulated computer keyboard;
a physical sensing device located within said interior surface; and
a computer processor operatively connected to said at least one projector and said physical sensing device;
wherein the computer processor receives and processes input from the physical sensing device to determine a first character being entered by the person within said physical touchpad.

16. The system of claim 15,
wherein the person is a driver of the vehicle; and
wherein the interior surface is a driver-facing surface of a steering wheel.

17. The system of claim 15,
wherein the physical sensing device comprises a physical touchpad.

18. The system of claim 15,
wherein the physical sensing device comprises a physical keyboard.

19. The system of claim 18,
wherein the physical keyboard is camouflaged within said interior surface when said image is not being projected.
